(19) United States
(12) Patent Application Publication
(10) Pub. No.: US 2012/0140932 A1
(43) Pub. Date: Jun. 7, 2012

(54) PROTECTION CIRCUIT AND ELECTRONIC DEVICE USING THE SAME

(75) Inventor: XING-HUA TANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/228,471

(22) Filed: Sep. 9, 2011

(30) Foreign Application Priority Data
Dec. 1, 2010 (CN) 201010568139.8

(51) Int. Cl. H04R 3/00

(52) U.S. Cl. 381/55

(57) ABSTRACT

A protection circuit includes a processing unit and a sensor. The processing unit drive a speaker to output sound. The sensor is used for detecting the temperature of the speaker, and generating an over-temperature signal when the detected temperature is higher than a predetermined temperature. The processing unit disables the speaker according to the over-temperature signal.

### BACKGROUND

1. Technical Field

The disclosed embodiments relate to protection circuits, and particularly relates to a protection circuit for protecting a speaker of an electronic device.

2. Description of Related Art

Various types of electronic devices, such as portable digital versatile disc (DVD) players, notebook computers, etc. are becoming thinner, and dissipating heat from these devices is a challenge.

When the audio output of such an electronic device, is at or near to the maximum output for an extended period, if not dissipated properly, the heat generated by the audio apparatus may damage the audio apparatus.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout two views.

FIG. 1 is a block diagram of an electronic device in accordance with one embodiment.

FIG. 2 is a circuit diagram of the electronic device in FIG. 1.

### DETAILED DESCRIPTION

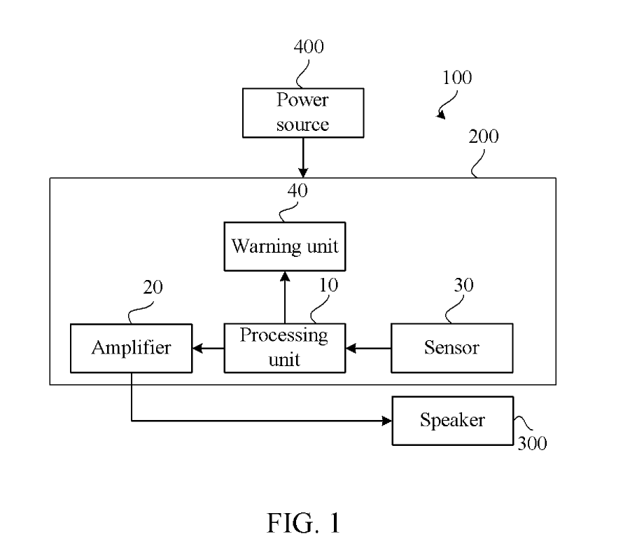

Referring to FIG. 1, an electronic device 100 includes a protection circuit 200 and a speaker 300. A power source 400 provides a supply voltage to power the electronic device 100. The protection circuit 200 is used for protecting the speaker 300 from being damaged when the temperature of the speaker 300 is too high. In this embodiment, the electronic device 100 may be a digital versatile disc (DVD) player capable of outputting sound.

The protection circuit 200 includes a processing unit 10, an amplifier 20, a sensor 30, and a warning unit 40. The processing unit 10 provides audio signals to the amplifier 20. The amplifier 20 amplifies the audio signals and provides the amplified audio signals to the speaker 300, and the speaker 300 outputs sound according to the amplified audio signals. In other embodiments, the amplifier 20 can be integrated in the processing unit 10.

The sensor 30 is used for detecting the temperature of the speaker 300, and generating a detecting signal when the detected temperature is higher than a predetermined temperature. The processing unit 10 disables the amplifier 20 according to the detecting signal, therefore the speaker 300 stops functioning, and the speaker 300 is protected from being damaged. In other embodiments, if the amplifier 20 is integrated in the processing unit 10, the processing unit 10 directly disables the speaker 300 according to the detecting signal.

The processing unit 10 further controls the warning unit 40 to output a warning signal according to the detecting signal, so as to inform users that the temperature of the speaker 300 is too high. In this embodiment, the warning unit 40 includes a light emitting diode (LED), and the LED emits light or flashes to indicate that the temperature of the speaker 300 is too high.

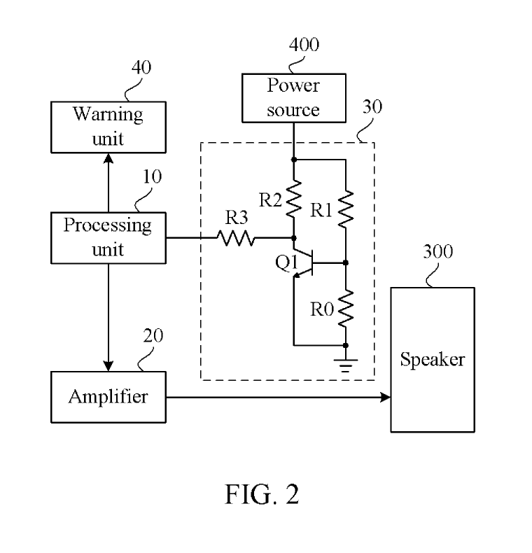

Referring to FIG. 2, the sensor 30 includes a thermal resistor R0, a first resistor R1, a second resistor R2, a third resistor R3, and a transistor Q1. The base of transistor Q1 is grounded via the thermal resistor R0, the base of transistor Q1 is further connected to the power source 400 via the first resistor R1, the collector of transistor Q1 is connected to the power source 400 via the second resistor R2, the collector of transistor Q1 is further connected to the processing unit 10 via the third resistor R3, the emitter of transistor Q1 is grounded. In this embodiment, the transistor Q1 is a pnp type transistor, and the thermal resistor R0 is a positive temperature coefficient (PTC) thermal resistor. The thermal resistor R0 and the speaker 300 are mounted on a printed circuit board, and the thermal resistor R0 is immediately adjacent to the speaker 300.

The principle of the electronic device 100 is illustrated as follows: the thermal resistor R0 and the first resistor R1 act as a voltage divider to the supply voltage of the power source 400. When the temperature of the speaker 300 is not more than the predetermined temperature, the resistance of the thermal resistor R0 is low, and the voltage at the base of transistor Q1 is not enough to turn on transistor Q1. Therefore, the supply voltage of the power source 400 is maintained to the processing unit 10 via the second resistor R2 and the third resistor R3, and the processing unit 10 receives a logic high level signal from the sensor 30. The processing unit 10 continues to output the audio signals to the speaker 300 via the amplifier 20, and the speaker 300 still outputs sound.

When the temperature of the speaker 300 is greater than the predetermined temperature, the resistance of the thermal resistor R0 increases, and the voltage at the base of transistor Q1 is enough to turn on transistor Q1. Therefore, the supply voltage of the power source 400 is not provided to the processing unit 10 via the second resistor R2 and the third resistor R3, and the processing unit 10 receives a logic low level signal from the sensor 30. The processing unit 10 disables the amplifier 20, and the speaker 300 ceases to function and is protected from being damaged.

Alternative embodiments will be apparent to those skilled in the art without departing from the spirit and scope of what is claimed. Accordingly, the present invention should be deemed not to be limited to the above detailed description, but rather only by the claims that follow and the equivalents thereof.

What is claimed is:

1. A protection circuit for protecting a speaker, the protection circuit comprising:
a processing unit for driving the speaker to output sound; and
a sensor for detecting the temperature of the speaker, and generating a detecting signal when the detected temperature is higher than a predetermined temperature;
wherein the processing unit disables the speaker according to the detecting signal.

2. The protection circuit of claim 1, wherein the sensor comprises a thermal resistor for detecting the temperature of the speaker, the thermal resistor and the speaker are mounted on a printed circuit board, and the thermal resistor is immediately adjacent to the speaker.

3. The protection circuit of claim 2, wherein the thermal resistor is a positive temperature coefficient thermal resistor.

4. The protection circuit of claim 2, wherein a power source provides a supply voltage to power the protection circuit, the sensor further comprises a first resistor, a second resistor, and a transistor, a base of transistor is grounded via the thermal resistor, the base of transistor is further connected to the power source via the first resistor, a collector of transistor is connected to the power source via the second resistor, the collector of transistor is further connected to the processing unit, an emitter of transistor is grounded.

5. The protection circuit of claim 4, wherein the sensor further comprises a third resistor, one end of the third resistor is connected to the processing unit, the other end of the third resistor is connected to the collector of transistor.

6. The protection circuit of claim 4, wherein the transistor is a pnp type transistor.

7. The protection circuit of claim 1, further comprising a warning unit, wherein the processing unit controls the warning unit to output warning signals according to the detecting signal.

8. The protection circuit of claim 7, wherein the warning unit comprises a light emitting diode (LED), the LED emits light or flashes to output warning signals.

9. An electronic device, comprising:
a speaker;
a processing unit for driving the speaker to output sound; and
a sensor for detecting the temperature of the speaker, and generating a detecting signal when the detected temperature is higher than a predetermined temperature;
wherein the sensor comprises a thermal resistor, the thermal resistor and the speaker are mounted on a printed circuit board, the thermal resistor is immediately adjacent to the speaker, the processing unit disables the speaker according to the detecting signal.

10. The electronic device of claim 9, wherein the thermal resistor is a positive temperature coefficient thermal resistor.

11. The electronic device of claim 9, wherein a power source provides a supply voltage to power the electronic device, the sensor further comprises a first resistor, a second resistor, and a transistor, a base of transistor is grounded via the thermal resistor, the base of transistor is further connected to the power source via the first resistor, a collector of transistor is connected to the power source via the second resistor, the collector of transistor is further connected to the processing unit, an emitter of transistor is grounded.

12. The electronic device of claim 11, wherein the sensor further comprises a third resistor, one end of the third resistor is connected to the processing unit, the other end of the third resistor is connected to the collector of transistor.

13. The electronic device of claim 11, wherein the transistor is a pnp type transistor.

14. The electronic device of claim 9, further comprising a warning unit, wherein the processing unit controls the warning unit to output warning signals according to the detecting signal.

15. The electronic device of claim 14, wherein the warning unit comprises a light emitting diode (LED), the LED emits light or flashes to indicate that the temperature of the speaker is high.

16. The electronic device of claim 13, wherein the detecting signal is a logic low level signal.
